(19) United States
(12) Patent Application Publication
(10) Pub. No.: US 2026/0141752 A1
(43) Pub. Date: May 21, 2026

(54) SYSTEM FOR PREDICTING HYDROPLANING EVENTS IN A VEHICLE

(71) Applicant: Mirza Faizan, Plano, TX (US)

(72) Inventors: Mirza Faizan, Plano, TX (US); Shaheer Irfan Hameed, Plano, TX (US); Sana Naeem, Plano, TX (US); Syed Naail Ayaz, Plano, TX (US); Jumana Janabi, Plano, TX (US); Reeva Joshi, Plano, TX (US); Sarah Nanam Kumar, Plano, TX (US); Anjhani Ramesh Kumar, Plano, TX (US); Daniel N. Yankovsky, Plano, TX (US); Sanjeev Venkatesh, Plano, TX (US); Rishi Sai Poola, Plano, TX (US); Aarush Siddabathuni, Plano, TX (US); Ibrahim Syed, Plano, TX (US); Suhani Sharma, Plano, TX (US); Sheik Ahamed Azigar Ali, Plano, TX (US)

(21) Appl. No.: 18/954,312

(22) Filed: Nov. 20, 2024

(51) Int. Cl. G07C 5/02; B60C 11/24; B60J 11/06

(52) U.S. Cl. CPC G07C 5/02; B60J 11/06; B60C 11/243

(57) ABSTRACT

The present invention relates to a system for predicting a hydroplaning event in a vehicle. The system comprises a tread detection sensor to capture information related to the tread depth of at least one tire, a road condition detection sensor to capture information about road conditions, including the presence of water on the road surface, and a vehicle speed detection unit to capture real-time speed data of the vehicle. The system further comprises a processing unit, communicably coupled to the sensors, which is configured to receive data from the sensors, determine tread depth, road condition, and vehicle speed, and calculate a risk score using a pre-trained machine learning model. When the determined risk score exceeds a threshold, the system predicts a hydroplaning event, thereby enhancing vehicle safety by providing timely alerts based on predictive analysis of driving conditions.

### TECHNICAL FIELD

This disclosure relates to vehicle safety systems and, more specifically, to a system designed to predict hydroplaning events in real-time using tire tread depth, road condition, and vehicle speed information, in conjunction with machine learning models to alert drivers of imminent hydroplaning risks.

### BACKGROUND

Hydroplaning is a critical driving hazard that occurs when a layer of water builds up between a vehicle's tires and the road surface, causing the tires to lose contact with the road. This separation drastically reduces traction, compromising the driver's ability to control the vehicle. Hydroplaning typically occurs when a vehicle travels at high speeds over a wet surface, with worn tire treads and poor road conditions further exacerbating the risk. When tires lose their grip, braking, steering, and overall stability are diminished, potentially leading to dangerous situations like skidding or veering off the road.

Modern vehicles are often equipped with safety features such as anti-lock braking systems (ABS) and traction control systems (TCS) to help mitigate loss of control. However, these systems are largely reactive in nature, meaning they engage only after hydroplaning has already begun. For example, ABS prevents wheel lockup and allows for controlled braking during a skid, while traction control regulates power to the wheels to reduce slip. Although helpful, these systems activate only in response to events as they happen and do not provide an early warning of imminent hydroplaning. This reactive approach limits the effectiveness of these systems, as they cannot prevent the initial loss of traction, which is the root cause of hydroplaning-related accidents.

There is a growing need for a proactive safety solution capable of predicting hydroplaning events before they occur, allowing the driver to take preventive actions. The present invention effectively overcomes the limitations and challenges associated with predicting hydroplaning events in vehicles, offering a reliable and comprehensive solution to enhance driving safety under varying road and environmental conditions.

### SUMMARY

A system for predicting a hydroplaning event in a vehicle comprises a tread detection sensor, to capture information related to tread depth of at least one tire of the vehicle. The system for predicting a hydroplaning event comprises a road condition detection sensor to capture information related to a road condition, such that a road condition includes a presence of water on a road surface. The system for predicting a hydroplaning event further comprises a vehicle speed detection unit, to capture information related to a real-time speed of the vehicle and a processing unit, communicably coupled with the tread detection sensor, the road condition detection sensor, and the vehicle speed detection sensor, such that the processing unit receives input data from the tread detection sensor, the road condition detection sensor, and the vehicle speed detection sensor. The processing unit determines the tread depth based on the captured information related to the tread depth, the road condition based on the captured information related to the road condition, and the real-time speed of the vehicle based on the captured information related to the real-time speed of the vehicle. The processing unit further determines a risk score based on the tread depth, the road condition and the real-time vehicle speed by employing a pre-trained machine learning model and predict a hydroplaning event, when the determined risk score is greater than a threshold risk score.

In an embodiment, the system for predicting a hydroplaning event further comprises an alert module communicably coupled to the processing unit, such that the alert module is configured to provide a warning to a driver of the vehicle based on the predicted hydroplaning event.

In an embodiment, the processing unit employs an augmented reality (AR) algorithm to determine the tire tread depth when the vehicle is stationary.

In an embodiment, the processing unit further operates a protection cover to protect the tread detection sensor when the vehicle is in motion.

In an embodiment, the processing unit employs a computer vision algorithm to determine the road condition.

In an embodiment, the machine learning model is pre-trained on historical data related to hydroplaning events.

In an embodiment, the machine learning model is pre-trained using supervised learning techniques.

In an embodiment, the alert module provides at least one of a visual, auditory, or haptic alert to the driver of the vehicle.

In an embodiment, the vehicle speed detection unit comprises a speed sensor integrated within the vehicle or a speed data input from a vehicle instrument cluster.

In an embodiment, the system for predicting a hydroplaning event is communicably coupled to a cloud-based data storage system for storing hydroplaning event data.

In an embodiment, the processing unit further, is periodically assessing the tire tread depth and alert a driver of the vehicle if the tread depth falls below a predetermined threshold.

In an embodiment, the processing unit further determines the risk score for each tire of the vehicle, if at least one tire of the vehicle has less tread depth than other tires of the vehicle.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of a system for predicting a hydroplaning event, in accordance with an embodiment of the present disclosure.

FIG. 2 illustrates a block diagram of a system for predicting a hydroplaning event, in accordance with another embodiment of the present disclosure.

FIG. 3 illustrates an exemplary scenario with implementation of a system for predicting a hydroplaning event, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processing units or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

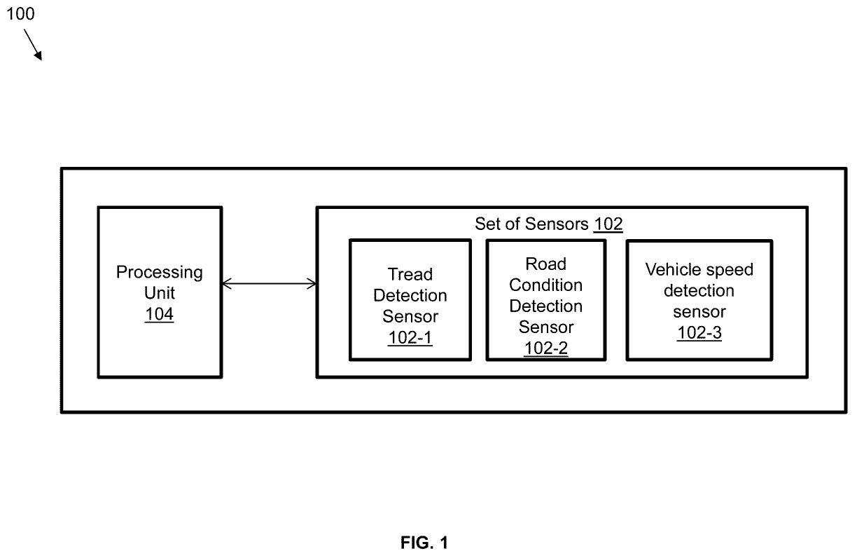

FIG. 1 illustrates a block diagram of a system for predicting a hydroplaning event, in accordance with an embodiment of the present disclosure, with reference to FIG. 1, there is shown a block diagram 100 of a system for predicting a hydroplaning event. The system for predicting the hydroplaning event may include a set of sensors 102 and a processing unit 104. The set of sensors 102 may further include tread detection sensor 102-1, road condition detection sensor 102-2, vehicle speed detection sensor 102-3.

The system for predicting a hydroplaning event utilizes various sensors 102 and the processing unit 104 to gather, analyze, and interpret real-time data to predict potential hydroplaning events. Each sensor 102 is designated for specific data collection, enabling comprehensive risk assessment based on tire tread condition, road surface state, and vehicle speed.

The tread detection sensor 102-1 capture information related to tread depth of at least one tire of the vehicle. The information related to tread depth may include raw sensor readings of the tire surface and treads. Tread depth is a critical factor in determining the tire's ability to channel water away from the tire's contact patch with the road, which is essential to maintain traction on wet surfaces. As tread depth diminishes, the risk of hydroplaning increases due to reduced water channeling ability. The tread detection sensor 102-1 may be an optical sensor to measure tread depth. The optical sensor operates by emitting light onto a surface, such as the tire or road, and analysing the reflected or scattered light to gather detailed information. For tread depth detection, the tread detection sensor 102-1 measures the distance between the emitted light source and the points on the tire surface to determine variations in tread depth. When analysing road conditions, the optical sensor identifies moisture, water accumulation, or irregularities on the road surface by capturing variations in reflectivity, texture, and pattern. Laser-based sensors are highly precise, employing laser beams to measure tread depth by focusing on specific points, making them ideal for identifying minute variations in tire wear. Infrared sensors analyse heat signatures and reflectivity changes in the infrared spectrum to detect road conditions, particularly effective for identifying water patches, as water absorbs and reflects infrared light differently from dry surfaces. LiDAR sensors (Light Detection and Ranging) use laser pulses to create detailed 3D maps of the road surface and tire structure, providing real-time insights into tread depth and road irregularities. Additionally, camera-based optical sensors leverage high-resolution cameras to capture visual data, which is a processed using computer vision algorithm to identify tread patterns and road moisture levels under varying lighting conditions. The tread detection sensor 102-1 transmits data on tread depth to the processing unit 104, enabling the system for predicting a hydroplaning event to assess whether the tread depth is adequate for wet conditions. If the tread depth is too shallow, the risk of hydroplaning increases, which the processing unit 104 factors into the overall risk assessment.

The road condition detection sensor 102-2 is responsible to capture information related to a road condition to detect the presence of water or other potentially hazardous substances like oil or ice on the road surface. The road condition detection sensor 102-2 functionality differentiates between dry and wet road conditions, which has a direct impact on the likelihood of hydroplaning. The ability to assess road wetness is crucial in evaluating hydroplaning risk, as hydroplaning typically occurs on wet or flooded surfaces. Different types of sensors may be utilized for this purpose. Optical or camera based sensors can analyze the road surface visually, detecting reflections from water. Computer vision algorithms integrated with this sensor can help distinguish water from other substances. Infrared (IR) sensors detect moisture on the road surface by sensing temperature changes or the reflective properties of water compared to dry pavement. Moisture sensor placed near the vehicle's underbody can detect the presence of water on the road by capturing conductivity changes when water contacts the sensor. The road condition detection sensor 102-2 sends road condition data to the processing unit 104, enabling the system to determine if the vehicle is driving on a wet surface, which heightens the hydroplaning risk.

The vehicle speed detection sensor 102-3 captures information related to a real-time speed of the vehicle. Higher speeds, especially on wet roads, greatly increase the likelihood of hydroplaning as the tires are less able to channel water effectively. The vehicle speed detection sensor 102-3 can be integrated with the vehicle's speedometer or onboard diagnostic (OBD) system, which provides speed data through a speed sensor already built into most modern vehicles. Alternatively, a dedicated GPS based speed sensor could be used for additional accuracy and independence from the vehicle's internal system.

The processing unit 104 is communicably linked to each sensor in the sensor assembly 102. This setup allows for efficient data transfer and processing. The processing unit 104 receives data inputs from the tread detection sensor 102-1, road condition detection sensor 102-2, and vehicle speed detection sensor 102-3, enabling it to process this information collectively to evaluate hydroplaning risk.

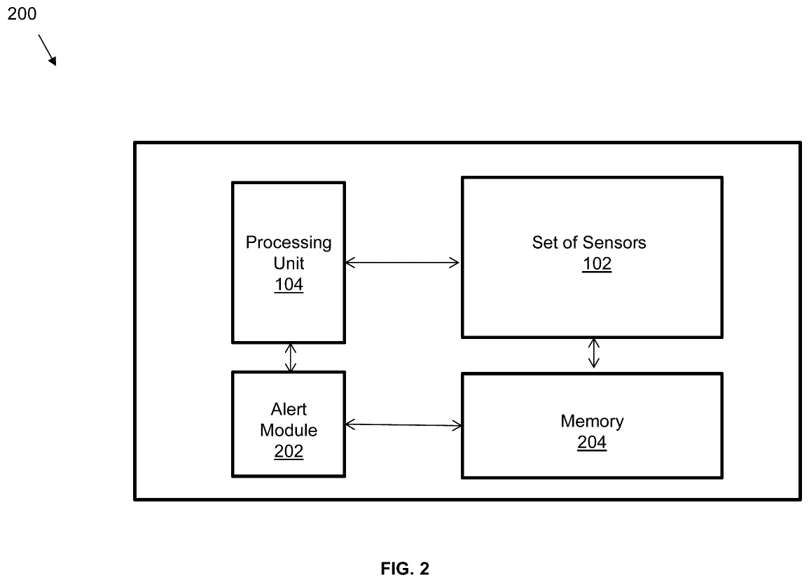

The processing unit 104 executes a pre-trained machine learning model specifically designed for hydroplaning risk assessment. The machine learning model has been trained using historical data on hydroplaning events, which includes variations in tread depth, road conditions, and vehicle speed. When data from the sensors is received, the processing unit 104 uses this model to calculate a risk score. This score reflects the probability of a hydroplaning event occurring under the current conditions. If the calculated risk score exceeds a predefined threshold, the processing unit 104 initiates a warning by activating an alert module that is shown in FIG. 2 that communicates with the driver through visual, auditory, or haptic alerts.

Moreover, the processing unit 104 predicts a hydroplaning event by calculating a risk score based on data received from the sensors 102 monitoring tread depth, road condition, and vehicle speed. Each sensor 102 provides real-time data, the tread detection sensor 102-1 measures tire tread depth, the road condition detection sensor 102-2 detects water presence on the road surface and the vehicle speed detection sensor 102-3 tracks the vehicle's speed. The processing unit 104 uses a pre-trained machine learning model that analyzes these inputs to generate a risk score, which represents the probability of hydroplaning under current conditions. The model has been trained on historical data of hydroplaning events, associating similar conditions with varying risk levels. When the calculated risk score exceeds a predefined threshold, indicating a high likelihood of hydroplaning, the processing unit 104 initiates an alert to notify the driver. This threshold-based approach allows the system to dynamically assess and respond to changing road and vehicle conditions, providing a proactive safety measure against hydroplaning.

The communication between the processing unit 104 and each sensor 102 can be established using wired or wireless protocols, depending on the configuration. In one embodiment, the system employs a Controller Area Network (CAN) bus to facilitate real-time data transfer between the processing unit 104 and sensors 102, ensuring that each component functions in sync for accurate, real-time predictions. Alternatively, wireless communication protocols like Bluetooth Low Energy (BLE) could be used for transmitting data from sensors 102, especially in retrofit applications where adding new wiring might be impractical.

Additionally, the processing unit 104 may include suitable logic, circuitry, and interfaces that may be configured to execute program instructions associated with a set of operations to be executed to determine weight distribution, provide the output signal or control the speaker, the display screen, or the haptic device. The processor may include one or more processing units, which may be implemented as an integrated processing unit or a cluster of processing units that perform the functions of the one or more processing units, collectively. The processing unit 104 may be implemented based on a number of processing unit technologies known in the art. Example implementations of the processing unit 104 may include, but are not limited to, an x86-based processing unit, a Graphics Processing Unit (GPU), a Reduced Instruction Set Computing (RISC) processing unit, an Application-Specific Integrated Circuit (ASIC) processing unit, a Complex Instruction Set Computing (CISC) processing unit, a microcontroller, a central processing unit (CPU), and/or other computing circuits.

FIG. 2 illustrates a block diagram of a system for predicting a hydroplaning event, in accordance with another embodiment of the present disclosure. With reference to FIG. 2, there is shown a block diagram 200 of a system for predicting a hydroplaning event. The system for predicting a hydroplaning event may include an alert module 202 and a memory 204. The system may also include all components of FIG. 1, specifically the set of sensors 102 and the processing unit 104.

The alert module 202 is communicably coupled with the processing unit 104 facilitating the transmission of timely and clear alerts to the driver when the system predicts a hydroplaning event. The functionality of the alert module 202 is based on the hydroplaning risk score determined by the processing unit 104. When the processing unit 104 calculates a risk score that exceeds a predefined threshold, this indicates a high probability of hydroplaning. At this point, the alert module 202 activates to notify the driver of the imminent risk. Depending on the configuration, the alert may take one or more forms of visual alert that gives a visual warning, such as a flashing light or message on the dashboard, which draws the driver's attention to the predicted hydroplaning risk. The alert may be an auditory alert that gives a sound or voice notification, such as a warning tone or verbal message, that directly informs the driver or alert may be a haptic feedback that gives a physical response, like a vibration or pulse on the steering wheel, which can be felt by the driver, prompting immediate attention. These alert options ensure that the driver receives a prompt and clear warning, using the most suitable method for the situation or driver preference. By offering visual, auditory, and haptic feedback, the system ensures that drivers are effectively alerted to hydroplaning risks, enhancing overall safety by supporting timely responses to hazardous conditions.

The memory 204 is communicably linked to the processing unit 104 and servers as a data repository for pre-trained machine learning models and historical hydroplaning data. The stored models, which are the product of supervised learning techniques, are crucial for the processing unit 104 to accurately predict hydroplaning events. The training process involves using large datasets of historical hydroplaning instances, including sensor data from various road conditions, tire tread depths, and vehicle speeds, to train the machine learning model. Once trained, the processing unit 104 can apply this model to real-time sensor inputs to calculate the risk score associated with the current driving conditions.

The system for predicting a hydroplaning event leverages data collected by the sensors 102, which includes tire tread depth, road conditions, and vehicle speed, to enable accurate and timely predictions. By utilizing pre-trained machine learning models for classification, regression, and time series analysis, the system can analyze these inputs comprehensively. Classification models identify whether conditions are likely to cause hydroplaning, while regression models assess the degree of risk based on specific parameters such as tread wear or water depth. Time series analysis evaluates patterns and trends in the input data over time, enabling dynamic risk assessment as conditions evolve. Together, these models allow the processing unit to calculate a risk score, determine the likelihood of a hydroplaning event, and provide actionable insights to enhance vehicle safety.

Random forest classifier model may be used for learning method that combines multiple decision trees to make a prediction. It is well-suited for problems involving structured data, such as the sensor 102 inputs. The random forest classifier model is effective at handling complex, non-linear relationships between these variables, and it is robust to noise in the data. The model can be pre-trained using historical hydroplaning event data, where the features are the sensor 102 readings and the target variable is the occurrence of hydroplaning. This pre-trained model can then be used to classify future sensor data into categories such as high or low risk.

Support vector machine (SVM) model is another classifier may be effective in high-dimensional spaces. It can be trained to predict hydroplaning risk by creating a hyper plane that separates different classes (e.g., “hydroplaning” vs. “no hydroplaning”) based on sensor 102 data. SVM can be used in conjunction with kernel tricks to handle non-linear relationships in the data, such as variations in road surface or vehicle speed. A pre-trained SVM model can be used to determine whether the current conditions meet the threshold for a hydroplaning event based on the features extracted from the sensor 102 data.

Convolutional Neural Network (CNN) model are typically used for image processing, they can also be applied to sensor data, especially when combined with visual input such as road condition images that is captured by the sensors 102. The CNN can learn spatial patterns in the road surface (e.g., detecting standing water or wet spots) and combine this information with the tire tread depth and vehicle speed data to predict hydroplaning. Pre-trained CNNs, such as those trained on large image datasets (e.g., ImageNet), can be fine-tuned with hydroplaning-specific data to improve the model's accuracy for our application.

Recurrent Neural Network (RNN) model with Long Short-Term Memory (LSTM), RNNs, particularly LSTMs may be used for time-series data, where the sequence of inputs over time influences the prediction. The vehicle speed and road condition data might have temporal dependencies, as the likelihood of hydroplaning can increase or decrease depending on changes over time. The LSTM model can be pre-trained on historical sequences of data and then applied to real-time sensor 102 inputs to predict hydroplaning risk dynamically. The model can learn patterns over time, such as the vehicle's speed in relation to road surface conditions, to generate a more accurate risk prediction for each moment.

K-Nearest Neighbors (KNN) is a simpler machine learning model that can be used to predict hydroplaning based on the nearest “neighbors” in the dataset. For instance, if the vehicle speed and road condition readings closely match those of a previously observed hydroplaning event, the model will predict a similar outcome. KNN can be useful for situations where a quick and intuitive prediction is needed without the complexity of more advanced algorithms like CNNs or RNNs. It can be pre-trained by clustering data points based on sensor readings and identifying risk thresholds that could lead to hydroplaning.

Further, the processing unit 104 communicably linked to both the memory 204 and the sensors 102, performs data analysis to calculate the hydroplaning risk score. This process involves receiving inputs from the tread detection sensor 102-1, road condition detection sensor 102-2 and vehicle speed detection sensor 102-3 as explained in FIG. 1. The memory 204 provides the processing unit 104 with access to a machine learning model that has been trained using supervised learning techniques on historical data about hydroplaning events. This enables the processing unit 104 to determine an accurate risk score based on real-time data and stored model parameters, facilitating real-time prediction.

In an embodiment, the processing unit 104 employs an augmented reality (AR) algorithm within the processing unit 104 to accurately determine tire tread depth when the vehicle is stationary. This AR algorithm processes visual data received from the tread detection sensor 102-1, allowing the processing unit 104 to analyze the tread patterns in detail. When the vehicle is stopped, the AR algorithm uses image processing techniques to enhance the accuracy of tread depth measurements by identifying wear patterns, depth variations, and specific tread indicators. By employing AR, the processing unit 104 can provide a precise assessment of the tire condition without requiring additional physical measurements, allowing for more efficient monitoring of tread wear. This information is then stored in memory 204 and can be used to assess the vehicle's readiness in potential hydroplaning conditions, contributing to overall road safety. The AR algorithm's capability to measure tread depth when the vehicle is stationary enhances the system's versatility, ensuring that accurate tire assessments can be conducted even without specialized equipment.

Feature detection and tracking algorithms may be used to identify specific features of the tire tread in real-time, such as edges, ridges, or patterns, and track them as the vehicle remains stationary. Oriented FAST and rotated BRIEF (ORB) and Scale-invariant feature transform (SIFT) are commonly used for feature detection and matching. Such algorithms may be employed to capture detailed images of the tire tread using the tread detection sensor 102-1 and analyze the depth by detecting the variations in the tread patterns.

3D object recognition algorithms may be used to create a 3D model of the tire tread surface and assess its depth. Simultaneous localization and Mapping (SLAM) and point cloud processing techniques can be used to generate a 3D representation of the tire, enabling precise depth measurement.

When the vehicle is stationary, the processing unit 104 employs such AR algorithms to the real-time data collected from the tread detection sensor 102-1. The algorithms analyze the tire tread images or video streams to generate an augmented reality display that overlays information such as the tread depth on the vehicle's screen. This provides the driver with immediate feedback about tire conditions. The depth estimation algorithms ensure that the assessment is accurate and reliable, enabling the system for predicting a hydroplaning event to accurately predict when the tires may be at risk for hydroplaning based on tread wear.

The system for predicting a hydroplaning event incorporates a computer vision algorithm within the processing unit 104 to accurately determine road conditions by analyzing data from the road condition detection sensor 102-2. The computer vision algorithm processes visual information from the sensor to identify indicators of road moisture, such as water pooling, surface reflections, or other signs of wetness that could increase the risk of hydroplaning. By analyzing these visual cues in real time, the computer vision algorithm enables the processing unit 104 to distinguish between dry and wet road conditions, as well as detect other potential hazards, such as icy patches or uneven surfaces. This processed information provides a reliable assessment of road conditions, which is then used to inform the hydroplaning risk score. The computer vision algorithm's ability to detect various road conditions dynamically enhances the system's predictive accuracy, allowing for better decision-making in diverse driving environments.

The vehicle speed detection sensor 102-3 obtains real-time speed data by accessing speed data input from the vehicle's instrument cluster. The speed sensor 102-3 directly measures the vehicle's speed and provides this information to the processing unit 104 for analysis. Alternatively, if speed data is available within the vehicle's instrument cluster, the system can retrieve this information as input, streamlining data collection without needing an additional sensor. By ensuring accurate and continuous access to vehicle speed data through either of these sources, the processing unit 104 can factor in the vehicle's current speed when calculating the hydroplaning risk score, contributing to precise, real-time assessments that reflect the actual driving conditions. This capability enhances the system for predicting a hydroplaning event predictive accuracy and supports timely alerts by the alert module 202.

Further, the system for predicting a hydroplaning event is communicably coupled to a cloud based storage system, enabling the storage and retrieval of hydroplaning event data. The processing unit 104 continuously collects and processes data from the various sensors 102, including information related to tire tread depth, road conditions, and vehicle speed. When a hydroplaning risk is predicted, this relevant data, along with the calculated risk score and event details, is transmitted to the cloud-based system for storage. Storing this data in the cloud allows for centralized access, facilitates historical analysis, and enables future model improvements by incorporating more diverse data points. Additionally, storing event data in the cloud allows for remote monitoring and real-time data sharing across multiple devices or vehicles, contributing to a broader understanding of hydroplaning events and potentially informing future safety improvements. The cloud-based system thus plays a crucial role in enhancing the system's functionality; ensuring data is securely stored, accessible, and available for continuous learning and refinement of the predictive model.

The processing unit 104 can determine the risk score for each of the tire vehicle especially when at least one tire has less tread depth than the others. In other words, the system is capable of individually evaluating each tire's condition and assessing the associated risk of hydroplaning for each tire based on its specific tread depth. The tread detection sensor 102-1 measures the tread depth of all tires, and the processing unit 104 analyzes the data to identify any tire that has worn down more than the others. When the tread depth of a particular tire is lower than the others, the processing unit 104 adjusts the hydroplaning risk score for that tire, considering it to be at a higher risk compared to the others with better tread depth. This tire-specific risk scoring allows for more accurate and nuanced hydroplaning predictions, as it accounts for the uneven wear of the tires, which could significantly affect the vehicle's overall stability and hydroplaning susceptibility. If the risk score for any tire exceeds the threshold, the alert module 202 will notify the driver of the potential danger, prompting them to take appropriate action, such as tire replacement or inspection.

Further, the processing unit 104 designed with an additional feature to enhance the durability and accuracy of the tread detection sensor 102-1 by using a protection cover controlled by the processing unit 104. When the vehicle is in motion, the processing unit 104 activates the protection cover to shield the tread detection sensor 102-1 from debris, moisture, and other environmental factors that could interfere with sensor performance or lead to inaccurate readings. This protection cover minimizes the accumulation of dirt or damage on the sensor 102, thereby extending its lifespan and ensuring reliable tread depth measurements over time. When the vehicle is stationary and the AR algorithm is employed to assess tread depth, the processing unit 104 can retract the protection cover, allowing the sensor to capture an unobstructed view of the tire tread. This feature allows the system to maintain sensor accuracy and functionality, even in challenging driving conditions, enhancing the overall effectiveness of the hydroplaning prediction system.

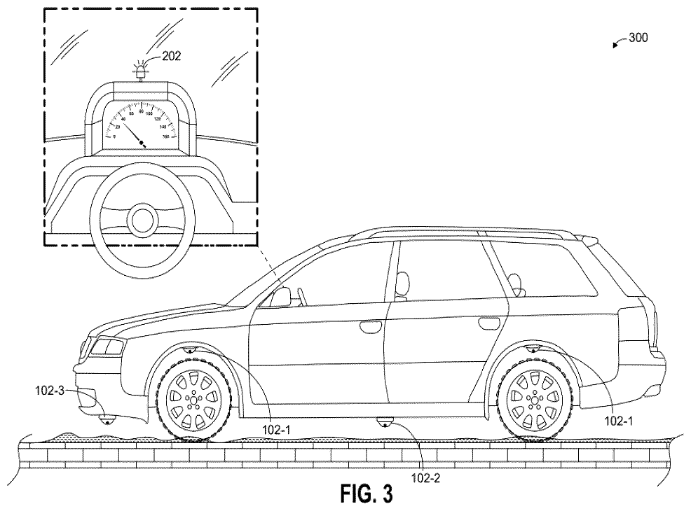

FIG. 3 illustrates an exemplary scenario of a system for predicting a hydroplaning event, in accordance with another embodiment of the present disclosure. As the figure illustrates an exemplary scenario diagram 300 of a system for predicting a hydroplaning event in accordance with the present disclosure operates by continuously gathering real-time data from various sensors integrated within the vehicle. The tread detection sensor 102-1, road condition detection sensor 102-2 and vehicle speed detection sensor 102-3 work together to monitor critical factors that contribute to the likelihood of hydroplaning. As the vehicle drives, the sensors collect data on the tread depth of the tires, the condition of the road surface (such as moisture levels), and the vehicle's speed.

Assume the tread detection sensor measures a tire tread depth of 2.5 mm, the road condition detection sensor detects a significant moisture level of 80% on the road surface, and the vehicle speed detection sensor records a real-time speed of 80 km/h.

The data from these sensors 102 is transmitted to the processing unit 104, which utilizes a pre-trained machine learning model to analyse these inputs. The model, trained on historical hydroplaning data, determines a risk score based on the inputs. For this example, the machine learning model assigns weights to each factor, the tire tread depth is considered critical due to its direct correlation with grip, the road moisture level indicates reduced friction, and high vehicle speed further increases the risk. Based on these inputs, the processing unit calculates a risk score of 0.85, where the threshold risk score is set to 0.75.

Since the calculated risk score of 0.85 exceeds the threshold, the processing unit identifies a high probability of a hydroplaning event. In such exemplary case, the processing unit sends a signal to the alert module 202, which promptly triggers a warning. A visual alert appears on the dashboard displaying “Hydroplaning Risk: Slow Down,” accompanied by an auditory warning beep and a vibrating steering wheel to ensure the driver is immediately aware of the danger.

Simultaneously, the memory 204 stores this event data, including the sensor 102 readings, calculated risk score, and driver response, for future analysis. This information is used to refine the machine learning model, improving the system's ability to predict hydroplaning events under similar or evolving conditions.

Therefore, the system for predicting a hydroplaning event operates as an intelligent and proactive safety mechanism, using real-time sensor data and advanced machine learning techniques to predict the likelihood of hydroplaning events. By providing timely alerts to the driver, the system enhances driving safety, reducing the risk of accidents caused by hydroplaning. The integration of sensor data, machine learning, and alert mechanisms ensures that the system can respond to changing road and vehicle conditions in real-time, making it an effective for enhancing road safety.

What is claimed is:

1. A system for predicting a hydroplaning event in a vehicle, wherein the system comprises:
a tread detection sensor configured to capture information related to tread depth of at least one tire of the vehicle;
a road condition detection sensor configured to capture information related to a road condition, wherein the road condition includes a presence of water on a road surface;
a vehicle speed detection unit configured to capture information related to a real-time speed of the vehicle; and
a processing unit, communicably coupled with the tread detection sensor, the road condition detection sensor, and the vehicle speed detection sensor, wherein the processing unit is configured to:
receive input data from the tread detection sensor, the road condition detection sensor, and the vehicle speed detection sensor;
determine the tread depth based on the captured information related to the tread depth, the road condition based on the captured information related to the road condition, and the real-time speed of the vehicle based on the captured information related to the real-time speed of the vehicle;
determine a risk score based on the tread depth, the road condition and the real-time vehicle speed by employing a pre-trained machine learning model; and
predict a hydroplaning event, when the determined risk score is greater than a threshold risk score.

2. The system of claim 1, wherein the system further comprises an alert module communicably coupled to the processing unit, wherein the alert module is configured to provide a warning to a driver of the vehicle based on the predicted hydroplaning event.

3. The system of claim 1, wherein the processing unit is configured to employ an augmented reality (AR) algorithm to determine the tire tread depth when the vehicle is stationary.

4. The system of claim 3, wherein the processing unit is configured to operate a protection cover to protect the tread detection sensor when the vehicle is in motion.

5. The system of claim 1, wherein the processing unit is configured to employ a computer vision algorithm to determine the road condition.

6. The system of claim 1, wherein the machine learning model is pre-trained on historical data related to hydroplaning events.

7. The system of claim 6, wherein the machine learning model is pre-trained using supervised learning techniques.

8. The system of claim 2, wherein the alert module provides at least one of: a visual, auditory, or haptic alert to the driver of the vehicle.

9. The system of claim 1, wherein the vehicle speed detection unit comprises a speed sensor integrated within the vehicle or a speed data input from a vehicle instrument cluster.

10. The system of claim 1, wherein the system is communicably coupled to a cloud-based data storage system for storing hydroplaning event data.

11. The system of claim 1, wherein the processing unit is further configured to periodically assess the tire tread depth and alert a driver of the vehicle if the tread depth falls below a predetermined threshold.

12. The system of claim 1, wherein the processing unit is configured to determine the risk score for each tire of the vehicle, if at least one tire of the vehicle has less tread depth than other tires of the vehicle.
